(19) United States
(12) Patent Application Publication
(10) Pub. No.: US 2026/0263996 A1
(43) Pub. Date: Sep. 10, 2026

(54) ROTARY BED DEVICE

(71) Applicant: IFP Energies nouvelles, Rueil-Malmaison (FR)

(72) Inventors: Philippe BÉARD, Rueil-Malmaison Cedex (FR); Samy LAABIDI, Rueil-Malmaison Cedex (FR); Marine MINIERE, Rueil-Malmaison Cedex (FR); Véronique PENIN, Rueil-Malmaison Cedex (FR); Thibault STHEME DE JUBECOURT, Rueil-Malmaison Cedex (FR)

(73) Assignee: IFP Energies nouvelles, Rueil-Malmaison (FR)

(21) Appl. No.: 19/560,336

(22) Filed: Mar. 9, 2026

(30) Foreign Application Priority Data
Mar. 10, 2025 (FR) 25/02.344

(51) Int. Cl. B01D 53/18; B01D 53/14; B01D 53/52; B01D 53/62; B01D 53/78

(52) U.S. Cl. CPC B01D 53/185; B01D 53/1468; B01D 53/1475; B01D 53/52; B01D 53/62; B01D 53/78; B01D 2252/20447; B01D 2252/20484; B01D 2257/304; B01D 2257/504; B01D 2258/0283

(57) ABSTRACT

A rotary-bed device comprises:

an inlet for a first fluid,

an inlet for a second fluid,

an outlet for the first fluid,

at least one outlet for the second fluid, and

a rotary contactor, comprising:

a rotary shaft,

a packed bed which is secured to the rotary shaft and configured to allow material to be transferred between the first fluid and the second fluid,

at least one outlet channel for the second fluid, configured to cause the second fluid to flow from the packed bed to said at least one outlet for the second fluid.

The at least one outlet channel for the second fluid is arranged inside the rotary shaft of the rotary contactor.

### TECHNICAL FIELD

The present invention relates to the field of rotary-contactor equipment. Such equipment is frequently used in chemical engineering, for a wide variety of industrial processes.

This equipment makes it possible to transfer material, or heat, between two fluids that have been brought into contact by virtue of the dispersion implemented by a rotary contactor.

### PRIOR ART

Rotary-contactor equipment has advantages over similar fixed-bed equipment. The centrifugal force experienced by the fluids owing to the rotation of the bed of the rotary contactor improves the efficiency of transfer between the two fluids. For the same treatment capacity, a piece of rotary-contactor equipment is thus more compact and weighs less than a similar piece of fixed-bed equipment. Less material is therefore used to manufacture the equipment, which generally makes the latter a more economical and more environmentally friendly solution. In addition, it is easier to install, in particular at sites where the space available is limited.

Some processes, such as capturing CO2 from combustion effluents from a factory, or from a thermal power plant, require a much higher treatment capacity than what conventional rotary-contactor equipment can provide. This increase in capacity can be obtained by simply increasing the size of the equipment. However, simply increasing the size of conventional equipment generally leads to a drop in efficiency, and causes the equipment to lose some of its advantages.

There is therefore a need to provide rotary-contactor equipment that is optimized for a large treatment capacity.

### SUMMARY

To this end, the invention proposes a rotary-bed device, comprising:
at least one inlet for a first fluid,
at least one first inlet/outlet for a second fluid,
at least one outlet for the first fluid,
   at least one second inlet/outlet for the second fluid,
   a rotary contactor, comprising:
      a rotary shaft,
      a packed bed which is secured to the rotary shaft and configured to allow a transfer of material and/or a transfer of heat between the first fluid and the second fluid,
      at least one flow channel for the second fluid, configured to cause the second fluid to flow from the packed bed to said at least one second inlet/outlet for the second fluid, or to cause the second fluid to flow from said at least one second inlet/outlet for the second fluid to the packed bed,

wherein the at least one flow channel for the second fluid is arranged inside the rotary shaft of the rotary contactor.

Arranging the flow channel for the second fluid inside the rotary shaft of the rotary contactor makes it possible to reduce the drop in pressure experienced by the flow of the second fluid. This improves the performance of the rotary-bed device. In particular, the treatment capacity is increased for the same size of the rotary-bed device.

The features listed in the following paragraphs can be implemented independently of one another or in any technically feasible combination:

Preferably, the rotary shaft is hollow along at least a part of its length, notably along most or the greater part of its length, notably along all of its length. This feature makes it possible, notably, to reduce the weight and increase the compactness of the device as a whole.

According to one embodiment, a part of said at least one flow channel (notably most or all of the channel) for the second fluid extends axially between the packed bed and a first axial end of the rotary shaft. In this instance, notably, the flow channel preferably has an axial inlet and/or outlet at one of its axial ends.

According to one embodiment, the at least one first inlet/outlet for the second fluid is an inlet, and the at least one second inlet/outlet for the second fluid is an outlet.

In other words, the second fluid is admitted into the rotary-bed device via the at least one first inlet/outlet, and leaves the rotary-bed device via the at least one second inlet/outlet.

The at least one first inlet/outlet is configured to receive a flow of a second fluid, and the at least one second inlet/outlet is configured to supply a flow of the second fluid.

The second fluid flows in the flow channel in a first flow direction.

According to another embodiment, the at least one first inlet/outlet for the second fluid is an outlet, and the at least one second inlet/outlet for the second fluid is an inlet.

In other words, the second fluid is admitted into the rotary-bed device via the at least one second inlet/outlet, and leaves the rotary-bed device via the at least one first inlet/outlet.

The at least one second inlet/outlet is configured to receive a flow of the second fluid, and the at least one first inlet/outlet is configured to supply a flow of the second fluid. The second fluid flows in the flow channel in a first flow direction.

The second fluid flows in the flow channel in a second flow direction counter to the first flow direction.

According to one exemplary embodiment, the first fluid is a liquid. The second fluid is a gas.

According to another exemplary embodiment, the first fluid is a liquid, and the second fluid is also a liquid.

A “liquid” is understood as meaning an entirely liquid phase, or a phase possibly also containing solid particles or gas bubbles in suspension. This term also encompasses a plurality of mutually immiscible phases (two for example).

The flow of the first fluid and of the second fluid can be of the counter-current type, i.e. in substantially parallel directions and opposite directions of movement. The two fluids flow in the packed bed of the rotary contactor in a radial direction.

The at least one flow channel for the second fluid causes the second fluid to flow from the packed bed to the at least one second inlet/outlet for the second fluid.

The flow of the first fluid and of the second fluid can be of the co-current type, i.e. in substantially parallel directions and one same flow direction. The two fluids flow in the packed bed of the rotary contactor in a radial direction.

In this case, the at least one flow channel for the second fluid causes the second fluid to flow from the second inlet/outlet for the second fluid to the packed bed.

The flow of the first fluid and of the second fluid can be of the cross-current type, i.e. in transverse directions of movement.

The first fluid flows in the packed bed of the rotary contactor in a radial direction. The second fluid flows in the packed bed in an axial direction.

The rotary shaft is hollow along at least a part of its length.

The rotary shaft comprises an outer lateral surface, and the at least one flow channel for the second fluid is radially on the inside of the outer lateral surface of the rotary shaft.

The rotary shaft comprises an inner lateral surface, and the at least one flow channel for the second fluid is radially delimited by the inner lateral surface of the rotary shaft.

According to one aspect of the rotary-bed device, a part of said at least one flow channel for the second fluid extends axially between the packed bed and a first axial end of the rotary shaft.

According to one embodiment of the rotary-bed device, the at least one flow channel for the second fluid is coaxial with the rotary shaft.

According to one embodiment, the rotary-bed device comprises:
a third inlet/outlet for the second fluid,
a second flow channel configured to cause the second fluid to flow from the packed bed to the third inlet/outlet for the second fluid, or to cause the second fluid to flow from the third inlet/outlet to the packed bed,

and the second flow channel is arranged inside the rotary shaft of the rotary contactor.

The rotary shaft thus forms two separate outlets for the flow of the second fluid. The cross section for the flow is increased, thereby making it possible to even further reduce the drop in pressure. The capacity of the rotary-bed device is improved.

A part of the second flow channel for the second fluid extends axially between the packed bed and a second axial end of the rotary shaft.

The third inlet/outlet for the second fluid has the same role as the second inlet/outlet. In other words, according to one embodiment, the second inlet/outlet and the third inlet/outlet are both inlets for the second fluid.

According to another embodiment, the second inlet/outlet and the third inlet/outlet are both outlets for the second fluid.

According to one embodiment of the rotary-bed device, the second flow channel for the second fluid is coaxial with the rotary shaft.

The first flow channel for the second fluid and the second flow channel for the second fluid are in fluidic communication.

The first flow channel for the second fluid and the second flow channel for the second fluid are coaxial.

According to one embodiment, the rotary-bed device comprises:
at least one distributor for the first fluid, configured to transfer the first fluid from the at least one inlet for the first fluid to the packed bed, and a portion of said at least one distributor for the first fluid is arranged inside the rotary shaft of the rotary contactor.

A portion of the at least one distributor for the first fluid radially faces the inner lateral surface of the rotary shaft.

The at least one distributor comprises at least one through-orifice for the first fluid.

The at least one distributor may comprise a set of through-orifices for the first fluid.

The at least one distributor comprises a tubular portion.

The at least one through-orifice for the first fluid is formed in a side wall of the tubular portion. The at least one through-orifice is arranged facing the packed bed in a radial direction.

The through-orifices can be axially offset along the tubular portion of the at least one distributor.

The through-orifices can be angularly offset along a part of the lateral surface of the tubular portion.

According to one exemplary embodiment, the end of the tubular portion of the at least one distributor for the first fluid is closed.

According to another exemplary embodiment, the end of the tubular portion of the at least one distributor for the first fluid is open.

According to one embodiment of the rotary-bed device, the tubular portion of the at least one distributor and the second flow channel of the rotary-bed device are coaxial.

The rotary-bed device can comprise two distributors.

The two distributors are for example arranged parallel to one another inside the rotary shaft. According to one aspect of the rotary-bed device, the rotary contactor comprises:
two end plates secured to the rotary shaft and extending transversely to the rotary shaft at a distance from one another,
a mixing chamber delimited in an axial direction by the two end plates, the mixing chamber extending radially between an inside diameter and an outside diameter, the packed bed being arranged in the mixing chamber.

The mixing chamber is partially filled by the packed bed.

The two end plates form a support, in an axial direction, for the packed bed.

According to one aspect of the rotary-bed device, the mixing chamber comprises a radially inner edge and a radially outer edge, and is configured to allow:
the first fluid to flow from the radially inner edge towards the radially outer edge.

According to one embodiment, the mixing chamber is configured to allow the second fluid to flow from the radially outer edge towards the radially inner edge.

According to another embodiment, the mixing chamber is configured to allow the second fluid to flow from the radially inner edge towards the radially outer edge.

According to another aspect of the rotary-bed device, the rotary contactor comprises a set of through-apertures for the passage of fluid.

Each through-aperture is configured to allow both passage of the first fluid and passage of the second fluid.

According to one embodiment, the rotary shaft of the rotary contactor comprises a side wall, and the set of through-apertures for the passage of fluid is arranged on a part of the side wall. This configuration gives the rotary shaft a higher stiffness.

The set of through-apertures for the passage of fluid is configured to allow the first fluid to pass from the at least one distributor to the mixing chamber.

According to one exemplary embodiment, the set of through-apertures for the passage of fluid is configured to allow the second fluid to pass from the mixing chamber to the at least one flow channel for the second fluid.

According to this exemplary embodiment, the set of through-apertures for the passage of fluid is configured to allow the second fluid to pass from the mixing chamber to the second flow channel for the second fluid.

According to another exemplary embodiment, the set of through-apertures for the passage of fluid is configured to allow the second fluid to pass from the at least one flow channel to the mixing chamber.

According to this other exemplary embodiment, the set of through-apertures for the passage of fluid is configured to allow the second fluid to pass from the second flow channel to the mixing chamber.

The through-apertures for the passage of fluid extend longitudinally in a direction parallel to the axis of the rotary shaft.

The through-apertures are distributed at constant angular intervals along the entire side wall of the rotary shaft of the rotary contactor.

The through-apertures all have the same shape.

The radially inner edge of the mixing chamber is adjacent to the through-apertures.

The packed bed extends radially from a part of the side wall of the rotary shaft to the outer peripheral edge of the end plates of the rotary contactor.

According to one embodiment of the rotary-bed device, the rotary contactor comprises a set of connecting elements connecting the end plates.

Each connecting element is secured to each of the end plates, and extends axially from one end plate to the other end plate, parallel to the axis of rotation.

The distance between the axis of a connecting element and the axis of the rotary shaft is for example constant.

The connecting elements are distributed around the entire circumference of the end plates. The connecting elements are spaced apart from one another. The free space between two consecutive connecting elements forms a through-aperture for the passage of the first fluid and the second fluid.

The connecting elements comprise rods. The angular distance between two consecutive connecting elements can be constant.

The rotary shaft can thus be interrupted in the axial zone comprised between the two end plates. This configuration makes it possible to limit the drop in pressure.

The end plates are mechanically connected to one another solely by the set of connecting elements.

The packed bed extends radially from the outer peripheral edge of the end plates towards the inside of the rotary contactor.

The rotary-bed device comprises an enclosure which forms a support member for retaining the rotary contactor.

The enclosure is fixed.

The enclosure is fluidtight.

According to one embodiment of the rotary-bed device, the rotary shaft is configured to pivot relative to the enclosure by means of a single guide bearing.

The single guide bearing for the rotary shaft is, for example, a rolling bearing.

The rolling bearing comprises an inner ring and an outer ring.

The rotary-bed device comprises a first seal and a second seal, the two seals being arranged radially between the rotary shaft and the enclosure, and axially on either side of the guide bearing.

The rotary-bed device comprises a third seal arranged axially between the rotary contactor and the enclosure.

The third seal surrounds the at least one distributor in a radial direction.

The third seal has an annular shape. The third seal has a central orifice surrounding the at least one distributor in a radial direction.

According to one embodiment of the rotary-bed device, the rotary shaft is radially inside the single guide bearing.

If the single guide bearing is a rolling bearing, the outer ring of the single rolling bearing is arranged in a recess in the enclosure.

If the single guide bearing is a rolling bearing, a radially outer portion of the rotary shaft is arranged in the inner ring of the single rolling bearing.

According to an embodiment variant of the rotary-bed device, the rotary shaft is radially outside the single guide bearing.

According to another embodiment of the rotary-bed device, the rotary shaft is configured to pivot relative to the enclosure by means of a first guide bearing and a second guide bearing.

The first guide bearing and the second guide bearing can be rolling bearings.

The first guide bearing and the second guide bearing are arranged one on each side of the mixing chamber in an axial direction.

According to one embodiment of the rotary-bed device, the rotary shaft is radially inside the first guide bearing.

If the first guide bearing is a rolling bearing, the outer ring of the first rolling bearing is arranged in a first recess in the enclosure.

A first portion of the rotary shaft is then arranged in the inner ring of the first rolling bearing. According to one embodiment of the rotary-bed device, the rotary shaft is radially inside the second guide bearing.

Similarly, if the second guide bearing is a rolling bearing, the outer ring of the second rolling bearing is arranged in a second recess in the enclosure.

A second portion of the rotary shaft is then arranged in the inner ring of the second rolling bearing.

For each guide bearing, a first seal is respectively arranged between a first outer lateral surface of the rotary shaft and a first part of the enclosure.

For each guide bearing, a second seal is respectively arranged between a second outer lateral surface of the rotary shaft and a second part of the enclosure.

According to one embodiment of the rotary-bed device, the first guide bearing is radially inside the rotary shaft.

If the first guide bearing is a rolling bearing, a first projecting portion of the enclosure is arranged in the inner ring of the first rolling bearing.

If the first guide bearing is a rolling bearing, the outer ring of the first rolling bearing is arranged in a first inner portion of the rotary shaft.

A part of the enclosure forms a portion of the at least one flow channel for the second fluid. According to one embodiment of the rotary-bed device, the second guide bearing is radially inside the rotary shaft.

If the second guide bearing is a rolling bearing, a second projecting portion of the enclosure is arranged in the inner ring of the second rolling bearing.

The outer ring of the second rolling bearing is then arranged in a second inner portion of the rotary shaft.

A part of the enclosure forms a portion of the second flow channel for the second fluid.

A first seal is arranged between a first portion of the inner lateral surface of the rotary shaft and a first part of the enclosure.

A second seal is arranged between a second portion of the inner surface of the rotary shaft and a second part of the enclosure.

According to one embodiment, the at least one outlet for the first fluid is arranged in a lower portion of the enclosure.

A lower portion of the enclosure may form a collection volume for the first fluid.

The first inlet/outlet for the second fluid is arranged in a portion of the enclosure arranged facing an end plate of the rotary contactor.

According to one exemplary embodiment of the rotary-bed device, the rotary shaft is oriented in a vertical direction.

According to this example, the first inlet/outlet for the second fluid is arranged on an upper face of the enclosure.

The at least one outlet for the first fluid and the at least one second inlet/outlet for the second fluid extend in parallel planes.

The at least one outlet for the first fluid and the at least one second inlet/outlet for the second fluid can be coplanar.

According to another exemplary embodiment of the rotary-bed device, the rotary shaft is oriented in a horizontal direction.

The rotary shaft can form any angle with the vertical axis.

The first inlet/outlet for the second fluid is arranged on a side face of the enclosure.

The at least one outlet for the first fluid and the at least one second inlet/outlet for the second fluid extend in perpendicular planes.

According to one embodiment of the rotary-bed device, the rotary contactor comprises:
a rotary shaft,
a first packed bed which is secured to the rotary shaft and configured to allow a transfer of material and/or a transfer of heat between the first fluid and the second fluid,
a second packed bed which is secured to the rotary shaft and configured to allow a transfer of material and/or a transfer of heat between the first fluid and the second fluid,

an outlet of the first packed bed being configured to supply a flow of the first fluid to the second packed bed,

an outlet of the second packed bed being configured to supply a flow of the second fluid to the first packed bed,
a flow channel for the second fluid, configured to cause the second fluid to flow from the first packed bed to the second inlet/outlet for the second fluid, and the flow channel for the second fluid is arranged inside the rotary shaft of the rotary contactor.

The rotary contactor comprises:
a first pair of end plates secured to the rotary shaft and extending transversely to the rotary shaft at a distance from one another,
a first mixing chamber delimited in an axial direction by the first pair of end plates, the first mixing chamber extending radially between an inside diameter and an outside diameter,

the first packed bed being arranged in the first mixing chamber,
a second pair of end plates secured to the rotary shaft and extending transversely to the rotary shaft at a distance from one another,
a second mixing chamber delimited in an axial direction by the second pair of end plates, the second mixing chamber extending radially between an inside diameter and an outside diameter,

the second packed bed being arranged in the second mixing chamber,

and one end plate of the second pair of end plates comprises at least one through-orifice configured to allow fluid to pass between the first packed bed and the second packed bed.

The at least one through-orifice is configured to allow the first fluid to flow from the first packed bed to the second packed bed.

The at least one through-orifice is configured to allow the second fluid to flow from the second packed bed to the first packed bed.

The rotary shaft is configured to pivot relative to the enclosure by means of a first guide bearing and a second guide bearing.

The first guide bearing and the second guide bearing are radially inside the rotary shaft. The invention also relates to any method for using the rotary-bed device described above, in which material and/or heat is transferred from one of the two fluids to the other fluid, the two fluids notably both being liquids (or mainly liquids if they can contain a phase/solid particles or gas bubbles in suspension), or one being a liquid and the other being a gas.

The device according to the invention thus has multiple applications, including any type of liquid-liquid extraction.

Non-limitingly, mention can be made notably of two applications for the device according to the present invention:

An application which is of interest to the invention, without the invention being limited thereto, relates to the deacidification of gaseous effluents such as natural gas, synthesis gases, combustion flue gases, refinery gases, tail gases from the Claus process, and biomass fermentation gases. The deacidification is carried out by washing with an absorbent liquid solution, with the acidic compound being transferred from the gaseous effluent to this absorbent solution. The absorbent solution makes it possible to absorb the acidic compounds present in the gaseous effluent, such as notably hydrogen sulfide H2S, mercaptans, carbon dioxide CO2, sulfur dioxide SO2, carbonyl sulfide COS and carbon disulfide CS2. The physicochemical characteristics of this absorbent solution are related to the nature of the gas to be treated: expected specification for the treated gas, selective removal of an acidic compound, thermal and chemical stability of the solution with respect to the various compounds present in the gaseous effluent to be treated. Of more particular interest in this case is the treatment of gaseous effluents with a view to capturing the carbon dioxide CO2 that they contain, the capture of CO2 by solvent being one of the ways of reducing the industrial emissions of CO2 and of limiting the build-up of this greenhouse gas in the atmosphere.

The other application, related to the previous one, concerns the regeneration of these absorbent liquids by bringing them into contact with, for example, a stripping gas which will take up the acidic compounds released by the solution, notably under the effect of a thermal input, this time with material being transferred from the liquid solution to a gas or gas mixture.

### BRIEF DESCRIPTION OF THE DRAWINGS

Other features, details and advantages will become apparent on reading the following detailed description and analysing the appended drawings, in which:

FIG. 1 is a schematic representation, from the side and in section, of a rotary-bed device according to a first embodiment,

FIG. 2 is a schematic representation, from the side and in section, of a rotary-bed device according to a second embodiment,

FIG. 3 is a schematic representation, from the side and in section, of a rotary-bed device according to a third embodiment,

FIG. 4 is a schematic representation, from the side and in section, of a rotary-bed device according to a fourth embodiment,

FIG. 5 is a schematic representation, from the side and in section, of the rotary contactor of a first variant of the rotary-bed device in FIG. 1,

FIG. 6 is a schematic representation, from the side and in section, of the rotary contactor of a second variant of the rotary-bed device in FIG. 1,

FIG. 7 is a schematic representation, from the side and in section, of a rotary-bed device according to a fifth embodiment,

FIG. 8 is a schematic representation, from the side and in section, of a rotary-bed device according to a sixth embodiment,

FIG. 9 is a schematic representation, from the side and in section, of a rotary-bed device according to a seventh embodiment,

FIG. 10 is a schematic representation, from the side and in section, of a rotary-bed device according to a variant of the rotary-bed device in FIG. 9.

### DESCRIPTION OF THE EMBODIMENTS

In order to make it easier to read the figures, the different elements are not necessarily depicted to scale. In these figures, identical elements bear the same references. Certain elements or parameters may be indexed, which is to say designated for example as first element or second element, or else as first parameter and second parameter, etc. This indexing is intended to differentiate between elements or parameters that are similar but not identical. This indexing does not imply that one element or parameter takes priority over another and the denominations may be interchanged. Where it is specified that a device comprises a given element, that does not exclude there being other elements present in that device.

In the various figures, the axis Z represents the vertical direction, the arrow pointing upwards. The axis X represents a horizontal axis.

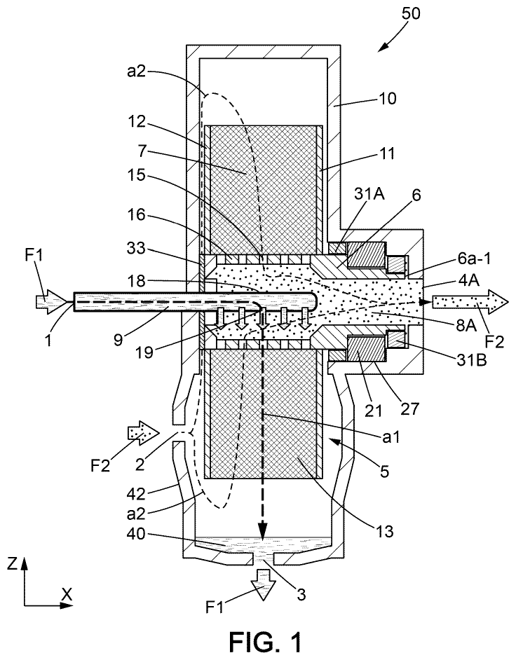

FIG. 1 schematically depicts a rotary-bed device 50 according to a first embodiment.

The rotary-bed device 50 comprises:
at least one inlet 1 for a first fluid F1,
at least one first inlet/outlet 2 for a second fluid F2,
at least one outlet 3 for the first fluid F1,
   at least one second inlet/outlet 4A for the second fluid F2,
a rotary contactor 5.

The rotary contactor 5 comprises:
a rotary shaft 6,
a packed bed 7 which is secured to the rotary shaft 6 and configured to allow a transfer of material or a transfer of heat between the first fluid F1 and the second fluid F2,
at least one flow channel 8A for the second fluid F2, configured to cause the second fluid F2 to flow from the packed bed 7 to said at least one second inlet/outlet 4A for the second fluid F2, or to cause the second fluid F2 to flow from said at least one second inlet/outlet 4A for the second fluid F2 to the packed bed 7,

and the at least one flow channel 8A for the second fluid F2 is arranged inside the rotary shaft 6 of the rotary contactor 5.

Arranging the flow channel 8A for the second fluid F2 inside the rotary shaft 6 of the rotary contactor 5 makes it possible to reduce the drop in pressure experienced by the flow of the second fluid F2. For example, in a facility which captures approximately 50000 tonnes of CO2 per year, which corresponds to a flow rate of the gaseous second fluid F2 of approximately 30000 m³/h (cubic metres per hour), it is possible to reduce the drop in pressure by approximately 10%.

This improves the performance of the rotary-bed device 50. In particular, the treatment capacity is increased for the same size of the rotary-bed device 50.

According to one embodiment, illustrated in FIG. 1, the at least one first inlet/outlet 2 for the second fluid F2 is an inlet, and the at least one second inlet/outlet 4A for the second fluid F2 is an outlet.

In other words, the second fluid F2 is admitted into the rotary-bed device 50 via the at least one first inlet/outlet 2, and leaves the rotary-bed device 50 via the at least one second inlet/outlet 4A. The flow channel 8A is in this case an outlet channel for the second fluid F2. The at least one first inlet/outlet 2 is configured to receive a flow of a second fluid F2, and the at least one second inlet/outlet 4A is configured to supply a flow of the second fluid F2.

The second fluid F2 flows in the flow channel 8A in a first flow direction.

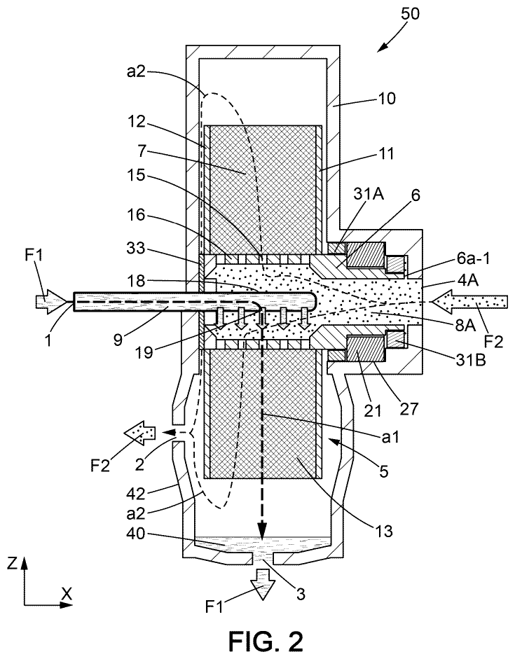

FIG. 2 depicts a second embodiment of the rotary-bed device 50.

According to this second embodiment, the at least one first inlet/outlet 2 for the second fluid F2 is an outlet, and the at least one second inlet/outlet 4A for the second fluid F2 is an inlet. In other words, the second fluid F2 is admitted into the rotary-bed device 50 via the at least one second inlet/outlet 4A, and leaves the rotary-bed device 50 via the at least one first inlet/outlet 2. The flow channel 8A is, according to this embodiment, an inlet channel for the second fluid F2.

The at least one second inlet/outlet 4A is thus configured to receive a flow of the second fluid F2, and the at least one first inlet/outlet 2 is configured to supply a flow of the second fluid F2. The second fluid F2 flows in the flow channel 8A in a second flow direction counter to the first flow direction.

The at least one inlet 1 is configured to receive a flow of a first fluid F1.

The at least one outlet 3 is configured to supply a flow of the first fluid F1.

The first fluid F1 and the second fluid F2 are in contact with one another as they flow in the packed bed 7 of the rotary contactor 5.

The centrifugal force generated by the rotation of the rotary contactor 5 makes it possible to force the first fluid F1 to migrate from the radially inner part of the packed bed 7 to the radially outer part of the packed bed 7. The centrifugal force makes it possible to improve the efficiency of the transfer between the two fluids, thereby increasing the treatment capacity, or makes it possible to reduce the quantity of packed bed used in the rotary contactor.

According to an exemplary embodiment of the rotary-bed device 50, the packed bed 7 allows material to be transferred from at least one specific constituent of the second fluid F2 to the first fluid F1.

According to another exemplary embodiment, the packed bed 7 allows material to be transferred from at least one specific constituent of the first fluid F1 to the second fluid F2. If material is transferred, the chemical composition of the first fluid F1 changes as the first fluid flows through the packed bed 7. Similarly, the chemical composition of the second fluid F2 changes as the second fluid flows through the packed bed 7.

As a result, the chemical composition of the first fluid F1 at the outlet 3 of the rotary-bed device 50 differs from the chemical composition of the first fluid F1 at the inlet 1 of the rotary-bed device 50. In the same way, the chemical composition of the second fluid F2 at the at least one second inlet/outlet 4A of the rotary-bed device 50 differs from the chemical composition of the second fluid F2 at the first inlet/outlet 2 of the rotary-bed device 50.

If heat is transferred, the temperature of the first fluid F1 changes as the first fluid flows through the packed bed 7. The temperature of the first fluid F1 at the outlet differs from the temperature of the first fluid at the inlet. Similarly, the temperature of the second fluid F2 changes as the second fluid flows through the packed bed 7.

The first fluid F1 may comprise particles. The particles may be present in the first fluid F1 at the inlet of the rotary-bed device 50, at the outlet of the rotary-bed device 50, or at both the inlet and the outlet of the rotary-bed device 50.

Similarly, the second fluid F2 may also comprise particles. As above, the particles may be present in the second fluid F2 at the inlet of the rotary-bed device 50, at the outlet, or at both the inlet and the outlet of the rotary-bed device 50.

According the example illustrated, the first fluid F1 is a liquid. The second fluid F2 is a gas. The liquid can absorb one or more chemical compounds present in the gas. One exemplary application is the capture of CO2 from the flue gases from a factory. Another exemplary application is the removal of hydrogen sulfide from a gaseous effluent. The liquid forms an absorbent solution.

In the case of the capture of CO2, the second fluid F2 is a gaseous mixture containing CO2 (carbon dioxide).

The first fluid F1 is for example a liquid solution completely or partially comprising a compound that reacts with CO2, making it possible to absorb the latter. The reactive compound(s) can be pure, diluted and in the form of an ionic liquid. They are selected from the group made up of amines, alkanolamines, azoles, ketones, oximes, lactams, enols, alcohols, thiols, amino acids, alkali metal salts of amino acids, amides, ureas, phosphates, carbonates or borates of alkali metals.

The following list provides a few examples of reactive compounds that can be used:

N,N,4-trimethyl-1-piperazinepropanamine; 1,2-bis(dimethylaminoethoxy)ethane; 2-[(2-hydroxyethyl)amino]-2-methyl-1-propanol; 2-[(2-hydroxypropyl)amino]-2-methyl-1-propanol.

The liquid solution may comprise a mass fraction of the nitrogen compound of between 10% and 100% by weight, and a mass fraction of water of between 0% and 90% by weight, the sum of the mass fractions of water and the nitrogen compound being greater than or equal to 50%. The second fluid F2 is unprocessed at the inlet of the rotary-bed device 50, and is purified at the outlet of the rotary-bed device 50.

The first fluid F1 is depleted at the inlet of the rotary-bed device, and enriched at the outlet.

According to another exemplary embodiment (not depicted), the first fluid F1 is a liquid, and the second fluid F2 is also a liquid.

Different types of flow of the first fluid F1 and the second fluid F2 are possible. In the various figures, the dashed line denoted by the sign a1 schematically shows the path taken by the first fluid F1. The dashed line denoted by the sign a2 schematically shows the path taken by the second fluid F2. The arrows schematically show the direction of the path taken.

The flow of the first fluid F1 and of the second fluid F2 can be of the counter-current type, i.e. in substantially parallel directions and opposite directions of movement.

The two fluids F1, F2 flow in the packed bed 7 of the rotary contactor 5 in a radial direction.

As depicted in FIG. 1, the first inlet/outlet 2 is in this case an inlet and the second inlet/outlet 4A is an outlet.

The at least one flow channel 8A for the second fluid F2 causes the second fluid F2 to flow from the packed bed 7 to the at least one second inlet/outlet 4A for the second fluid F2. According to another embodiment, the flow of the first fluid F1 and of the second fluid F2 can be of the co-current type, i.e. in substantially parallel directions and one same flow direction. The two fluids F1, F2 flow in the packed bed 7 of the rotary contactor 5 in a radial direction.

In this case, and as depicted in FIG. 2, the second inlet/outlet 4A is an inlet and the first inlet/outlet 2 is an outlet.

The at least one flow channel 8A for the second fluid F2 causes the second fluid F2 to flow from the second inlet/outlet 4A for the second fluid F2 to the packed bed 7.

In other words, the second embodiment differs from the first embodiment by the flow direction of the second fluid F2. The flow of the first fluid F1 remains unchanged between the two embodiments.

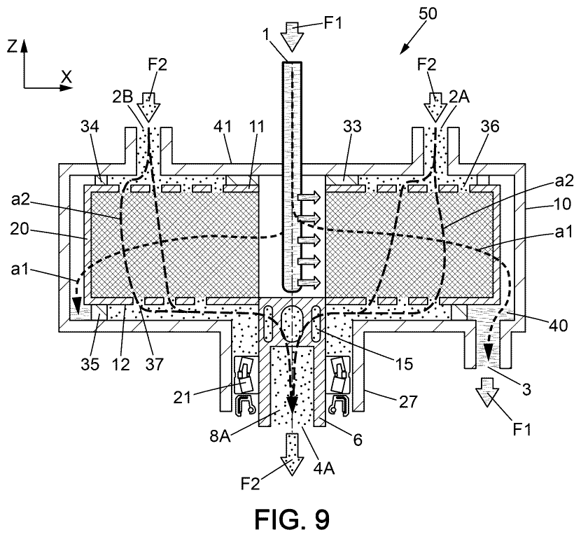

According to another embodiment, illustrated in FIG. 9, the flow of the first fluid F1 and of the second fluid F2 can be of the cross-current type, i.e. in substantially transverse, in other words substantially perpendicular, directions of movement.

The first fluid F1 flows through the packed bed 7 of the rotary contactor 5 in a radial direction, i.e. transversely to the direction of the axis of the rotary shaft 6. The second fluid F2 flows through the packed bed 7 in an axial direction, i.e. parallel to the direction of the axis of the rotary shaft 6.

In this embodiment, the first inlet/outlet 2 is an inlet and the second inlet/outlet 4A is an outlet.

The rotary shaft 6 extends along an axis D.

The rotary shaft 6 is hollow along at least a part of its length.

The rotary shaft 6 comprises an outer lateral surface 6L-e, and the at least one flow channel 8A for the second fluid F2 is radially on the inside of the outer lateral surface 6L-e of the rotary shaft 6. T

he rotary shaft 6 comprises an inner lateral surface 6L-i, and the at least one flow channel 8A for the second fluid F2 is radially delimited by the inner lateral surface 6L-i of the rotary shaft 6. The inner lateral surface 6L-i of the rotary shaft 6 is in contact with the second fluid F2. In other words, the inner lateral surface 6L-i of the rotary shaft 6 forms a part of the flow channel 8A for the second fluid F2.

A part of said at least one flow channel 8A for the second fluid F2 extends axially between the packed bed 7 and a first axial end 6a-1 of the rotary shaft 6.

The at least one flow channel 8A for the second fluid F2 is coaxial with the rotary shaft 6. The rotary shaft 6 is thus open in its part closest to its axis D. The at least one flow channel 8A is for example formed by a hole drilled through the shaft 6.

The rotary-bed device 50 comprises an enclosure 10 which forms a support member for holding the rotary contactor 5.

The enclosure 10 forms a frame relative to which the rotary contactor 5 can pivot. The enclosure 10 is fixed.

The first fluid F1 and the second fluid F2 flow inside the enclosure 10. The enclosure 10 is fluidtight.

The enclosure 10 contains the first fluid F1 and the second fluid F2.

The enclosure 10 is rigid. Rigid is understood as meaning that the enclosure 10 undergoes only elastic, and thus reversible deformations during nominal use of the rotary-bed device 50.

The enclosure 10 forms a volume for receiving the rotary contactor 5.

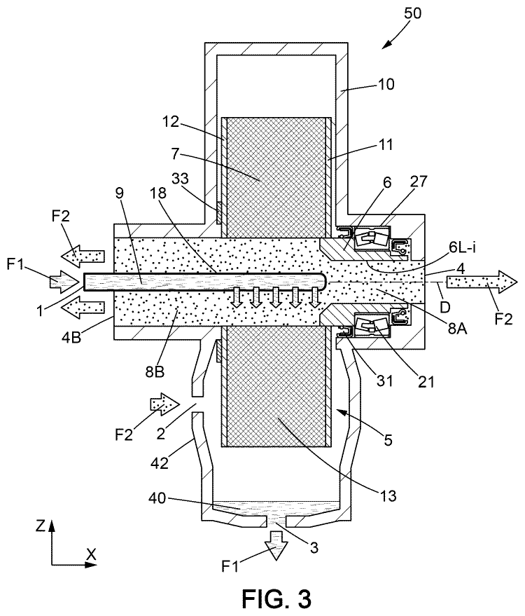

FIG. 3 depicts a third embodiment, which differs from the first embodiment by the number of outlets for the second fluid F2.

In this embodiment, the rotary-bed device 50 comprises a first outlet 4A arranged in the rotary shaft 6, and a second outlet 4B arranged in a wall of the enclosure 10.

This increases the cross section for the flow of the second fluid F2, thereby making it possible to reduce the overall drop in pressure in the rotary-bed device.

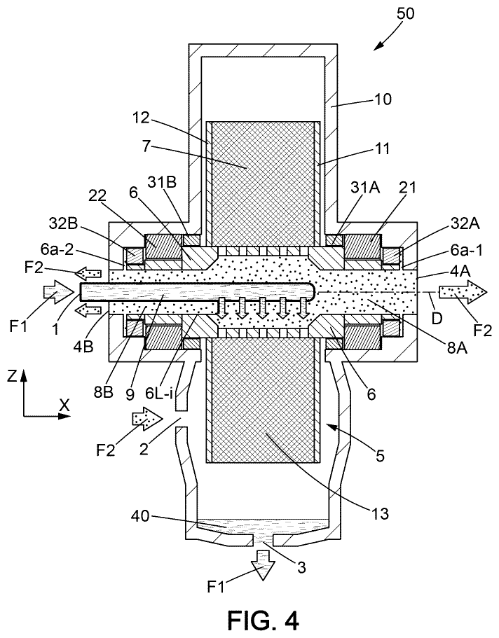

FIG. 4 depicts a fourth embodiment of the rotary-bed device 50, which comprises two inlets/outlets arranged in the shaft.

In this embodiment, the rotary-bed device 50 comprises:
a third inlet/outlet 4B for the second fluid F2,
a second flow channel 8B configured to cause the second fluid F2 to flow from the packed bed 7 to the third inlet/outlet 4B for the second fluid F2, or to cause the second fluid F2 to flow from the third inlet/outlet 4B to the packed bed 7,

and the second flow channel 8B is arranged inside the rotary shaft 6 of the rotary contactor 5. The rotary shaft 6 thus forms two separate outlets for the flow of the second fluid F2. The cross section for the flow of the second fluid F2 is increased, thereby making it possible to even further reduce the drop in pressure. This improves the capacity of the rotary-bed device 50. For the same capacity, its size can be reduced.

A part of the second flow channel 8B for the second fluid F2 extends axially between the packed bed 7 and a second axial end 6a-2 of the rotary shaft 6.

The second axial end 6a-2 of the rotary shaft 6 is opposite the first axial end 6a-1 of the rotary shaft 6.

The third inlet/outlet 4B for the second fluid F2 has the same role as the second inlet/outlet 4A. According to the embodiment in FIG. 4, the second inlet/outlet 4A and the third inlet/outlet 4B are both outlets for the second fluid F2.

The rotary shaft 6 is open at each of its axial ends, and the two open portions form a portion of the outlet channel for the second fluid F2.

The rotary shaft 6 can be symmetrical with respect to a plane perpendicular to the axis D of the rotary shaft.

According to a variant (not depicted), the second inlet/outlet 4A and the third inlet/outlet 4B can both be inlets for the second fluid F2.

According to the embodiment illustrated in FIG. 4, the second flow channel 8B for the second fluid F2 is coaxial with the rotary shaft 6.

The first flow channel 8A for the second fluid F2 and the second flow channel 8B for the second fluid F2 are coaxial.

The first flow channel 8A and the second flow channel 8B can have the same diameter.

The first flow channel 8A for the second fluid F2 and the second flow channel 8B for the second fluid F2 are in fluidic communication.

A detailed description will now be given of the device for introducing the first fluid F1, which in this case is a liquid, into the rotary-bed device 50.

The rotary-bed device 50 comprises at least one distributor 9 for the first fluid F1. The distributor 9 for the first fluid F1 is configured to cause the first fluid F1 to pass from the at least one inlet 1 for the first fluid F1 to the packed bed 7. A portion of said at least one distributor 9 for the first fluid F1 is arranged inside the rotary shaft 6 of the rotary contactor 5.

This case is illustrated notably in FIG. 4.

A portion of the at least one distributor 9 for the first fluid F1 radially faces the inner lateral surface 6L-i of the rotary shaft 6.

The at least one distributor 9 comprises at least one through-orifice 19 for the first fluid F1.

The first fluid F1, admitted into the distributor 9 at the inlet 1, leaves the distributor 9 at the through-orifice 19, and flows to the packed bed 7.

The at least one distributor 9 comprises in this case a tubular portion 18.

The at least one through-orifice 19 for the first fluid F1 is formed in a side wall of the tubular portion 18.

The at least one through-orifice 19 is arranged facing the packed bed 7 in a radial direction. According to the example illustrated, the at least one distributor 9 comprises a set of through-orifices 19 for the first fluid F1.

The through-orifices 19 can be axially offset along the tubular portion 18 of the at least one distributor 9.

The through-orifices 19 can be angularly offset along a part of the lateral surface of the tubular portion 18.

For example, the distributor 9 comprises several rows of through-orifices 19. Each row comprises several through-orifices axially offset along the tubular portion.

The rows are distributed at regular angular intervals along the tubular portion. Each row forms a generatrix of the tubular portion.

For example, the distributor 9 comprises nine rows of through-orifices, distributed at an interval of 40° around the entire periphery of the tubular portion. Each row comprises for example three through-orifices.

The spacing between the first and the second orifice of a row is the same as the spacing between the second orifice and the third orifice of this row.

According to the example illustrated, the end of the tubular portion 18 of the at least one distributor 9 for the first fluid F1 is closed.

According to a variant (not depicted), the end of the tubular portion 18 of the at least one distributor 9 for the first fluid F1 can be open. The distributor 9 then has the form of a tube open at each of its ends.

The first fluid F1 leaves the distributor 9 via the through-orifice 19 or, if appropriate, the set of through-orifices 19, and reaches the packed bed 7 of the rotary contactor 5.

According to the example illustrated, the tubular portion 18 of the at least one distributor 9 and the second flow channel 8B of the rotary-bed device 50 are coaxial.

The shape of the distributor 9, and the number and spatial arrangement of the through-orifices 19 can differ from the example illustrated.

The number of distributors can also vary.

The rotary-bed device 50 can thus comprise two distributors.

The two distributors are for example arranged parallel to one another inside the rotary shaft 6. The two distributors can be arranged symmetrically with respect to the axis D of the rotary shaft 6.

Each distributor delivers a portion of the total flow of the first fluid F1.

A detailed description will now be given of the rotary contactor 5.

The rotary contactor 5 comprises:
two end plates 11, 12 secured to the rotary shaft 6 and extending transversely to the rotary shaft 6 at a distance from one another,
a mixing chamber 13 delimited in an axial direction by the two end plates 11, 12.

The mixing chamber 13 extends radially between an inside diameter di and an outside diameter de. The packed bed 7 is arranged in the mixing chamber 13.

The mixing chamber 13 is partially filled by the packed bed 7.

The two end plates 11, 12 form a support, in an axial direction, for the packed bed 7.

Each end plate 11, 12 has the form of a disc which is open in its centre. The hollow is circular in shape and notably allows the insertion of the rotary shaft 6. The two end plates 11, 12 are offset along the rotary shaft 6. The volume delimited by the two end plates 11, 12 is filled by the packed bed 7.

Each end plate 11, 12 comprises a device for retaining the packed bed 7. This retention device has not been depicted.

The packed bed 7 is thus fixed with respect to the end plates 11, 12.

The mixing chamber 13 comprises a radially inner edge 13-i and a radially outer edge 13-e, and is configured to allow the first fluid F1 to flow from the radially inner edge 13-I towards the radially outer edge 13-e.

The centrifugal force generated by the rotation of the rotary contactor 5 tends to cause the liquid F1 to pass from the region close to the axis D of the rotary shaft 6 towards the outer periphery of the packed bed 7.

According to the embodiment in FIG. 1 and according to the embodiments in FIGS. 3 to 7, the flow of the liquid F1 and of the gas F2 is of the counter-current type.

The mixing chamber 13 is thus configured to allow the second fluid F2 to flow from the radially outer edge 13-e towards the radially inner edge 13-i.

The first fluid F1 and the second fluid F2 thus have opposite directions of movement.

According to the embodiment in FIG. 2, the flow of the liquid F1 and of the gas F2 is of the co-current type.

In this case, the mixing chamber 13 is configured to allow the second fluid F2 to flow from the radially inner edge 13-i towards the radially outer edge 13-e.

The first fluid F1 and the second fluid F2 thus have the same directions of movement through the packed bed 7.

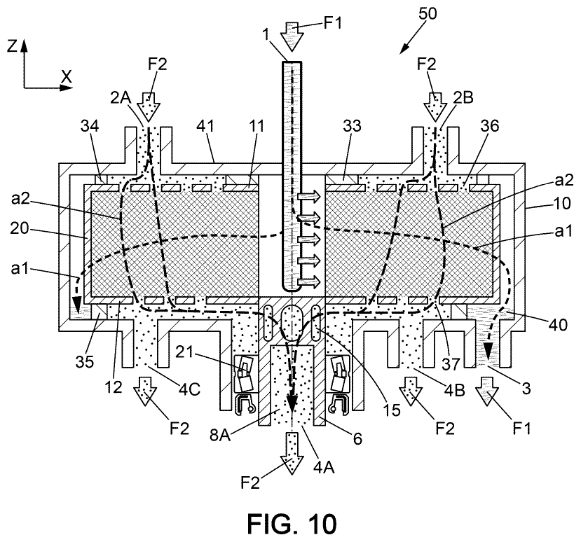

According to the embodiment in FIGS. 9 and 10, the flow of the liquid F1 and of the gas F2 is of the cross-current type. This embodiment will be described later on.

According to the embodiments in FIGS. 1 to 4, 7, and 9 and 10, the first inlet/outlet 2 for the second fluid F2 is arranged in a portion of the enclosure 10 arranged facing an end plate 11 of the rotary contactor 5.

The rotary contactor 5 may comprise a set of through-apertures 15 for the passage of fluid. Each through-aperture 15 is configured to allow both passage of the first fluid F1 and passage of the second fluid F2.

According to the embodiments corresponding to a flow of the first fluid F1 and of the second fluid F2 of the counter-current type, the first fluid F1 and the second fluid F2 pass through the through-apertures 15 in opposite flow directions.

According to the embodiment in FIG. 2, corresponding to a flow of the co-current type, the first fluid F1 and the second fluid F2 pass through the through-apertures 15 in the same flow direction.

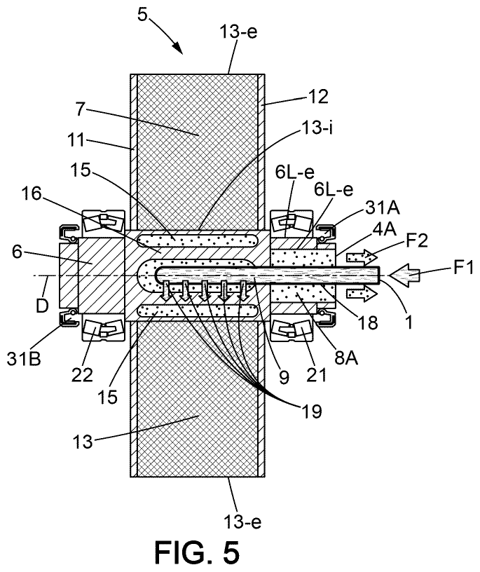

According to the embodiments in FIGS. 1 and 2 and in FIGS. 4 and 5, the rotary shaft 6 comprises a portion connecting the first end plate 11 to the second end plate 12.

The rotary shaft 6 of the rotary contactor 5 comprises a side wall 16, and the set of through-apertures 15 for the passage of fluid is arranged on a part of the side wall 16.

The wall 16 is secured to the first end plate 11 and the second end plate 12, and connects the first end plate 11 to the second end plate 12.

This configuration gives the rotary shaft 6 a higher stiffness, conducive to operation at a high rotational speed.

The set of through-apertures 15 for the passage of fluid is configured to allow the first fluid F1 to pass from the at least one distributor 9 to the mixing chamber 13.

According to the embodiments in which the flow of the two fluids F1, F2 is of the counter-current type, the set of through-apertures 15 for the passage of fluid is configured to allow the second fluid F2 to pass from the mixing chamber 13 to the at least one flow channel 8A for the second fluid F2.

According to the embodiments in which the rotary bed 5 comprises two outlets 4A, 4B, the set of through-apertures 15 for the passage of fluid is configured to allow the second fluid F2 to pass from the mixing chamber 13 to the second flow channel 8B for the second fluid F2.

According to the embodiments in which the flow of the two fluids F1, F2 is of the co-current type, the set of through-apertures 15 for the passage of fluid is configured to allow the second fluid F2 to pass from the at least one flow channel 8A to the mixing chamber 13.

Similarly, for the variants in which the rotary bed 5 comprises two inlets 4A, 4B, the set of through-apertures 15 for the passage of fluid is configured to allow the second fluid F2 to pass from the second flow channel 8B to the mixing chamber 13.

According to the example illustrated in FIG. 5, the through-apertures 15 for the passage of fluid extend longitudinally in a direction parallel to the axis of the rotary shaft 6.

The through-apertures 15 are for example distributed at constant angular intervals along the entire side wall 16 of the rotary shaft 6 of the rotary contactor 5.

In this example, the through-apertures 15 all have the same shape.

The radially inner edge 13-i of the mixing chamber 13 is adjacent to the through-apertures 15. The packed bed 7 extends radially from a part of the side wall 16 of the rotary shaft 6 to the outer peripheral edge of the end plates 11, 12 of the rotary contactor 5.

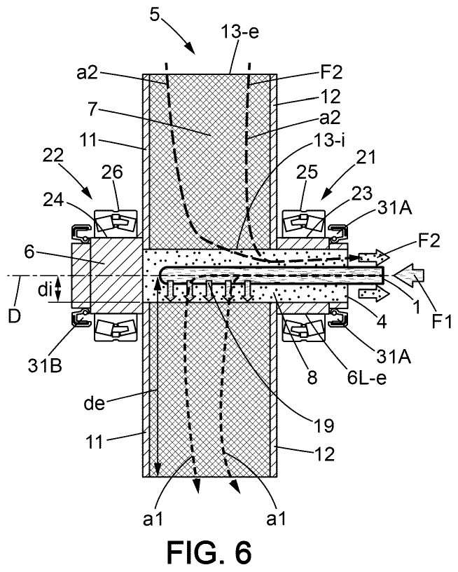

According to the embodiment in FIG. 3 and according to the embodiments in FIGS. 6 to 10, the rotary shaft 6 is interrupted in the zone comprised axially between the two end plates 11, 12. According to these embodiments, the rotary contactor 5 comprises a set of connecting elements 20 connecting the end plates 11, 12.

This configuration makes it possible to increase the cross section for the flow of the two fluids F1, F2 and thus to reduce the drop in pressure.

The end plates 11, 12 are mechanically connected to one another solely by the set of connecting elements 20.

Each connecting element 20 is secured to each of the end plates, and extends axially from one end plate 11 to the other end plate 12, parallel to the axis of rotation.

The connecting elements 20 may comprise rods.

The distance between the axis of a connecting element 20 and the axis of the rotary shaft 6 is for example constant.

The connecting elements 20 are distributed around the entire circumference of the end plates 11, 12. The connecting elements 20 are spaced apart from one another. The angular distance between two consecutive connecting elements can be constant.

The free space between two consecutive connecting elements 20 forms a through-aperture for the passage of the first fluid F1 and the second fluid F2.

The packed bed 7 extends radially from the outer peripheral edge of the end plates 11, 12 towards the inside of the rotary contactor 5.

Several types of mechanical connection between the rotary shaft 6 and the rotary contactor 5 are possible.

According to the embodiments in FIGS. 1 to 3, and according to the embodiment in FIGS. 9 and 10, the rotary shaft 6 is configured to pivot relative to the enclosure 10 by means of a single guide bearing 21.

The guide bearing is for example a rolling bearing, as depicted in FIGS. 1 and 2.

The rolling bearing 21 comprises an inner ring 23 and an outer ring 25.

The rolling bearing 21 may be a ball bearing or a roller bearing. The rolling bearing 21 may comprise two rows of balls or two rows of rollers.

As depicted notably in FIGS. 1 and 2, the rotary-bed device 50 comprises a first seal 31A and a second seal 31B, the two seals 31A, 31B being arranged radially between the rotary shaft 6 and the enclosure 10, and axially on either side of the guide bearing 21.

The first seal 31A and the second seal 31B provide a dynamic fluidtightness, i.e. a fluidtightness between a fixed component and a shaft which is able to pivot relative to this fixed component.

The seals 31A, 31B isolate the guide bearing 21 from the first fluid F1 and from the second fluid F2.

According to the embodiments in FIGS. 1 to 3, and according to the embodiment in FIGS. 9 and 10, the rotary-bed device 50 comprises a third seal 33 arranged axially between the rotary contactor 5 and the enclosure 10.

The third seal 33 surrounds the at least one distributor 9 in a radial direction.

The third seal 33 has an annular shape. The third seal 33 has a central orifice surrounding the at least one distributor 9 in a radial direction.

The third seal 33 provides a dynamic fluidtightness and isolates the outside of the enclosure 10 from the first fluid F1 and from the second fluid F2.

According to the embodiments in FIGS. 1 to 3 and FIGS. 9 and 10, the rotary shaft 6 is radially inside the single guide bearing 21.

In FIGS. 3, 9 and 10, the outer ring 23 of the single rolling bearing 21 is arranged in a recess 27 in the enclosure 10.

A radially outer portion of the rotary shaft 6 is arranged in the inner ring 23 of the single rolling bearing 21.

According to an embodiment variant (not depicted) of the rotary-bed device 50, the rotary shaft 6 is radially outside the single guide bearing 21.

According to the embodiments in FIGS. 4 to 8, the rotary shaft 6 is configured to pivot relative to the enclosure 10 by means of a first guide bearing 21 and a second guide bearing 22.

The first guide bearing 21 and the second guide bearing 22 are arranged one on each side of the mixing chamber 13 in an axial direction.

In other words, the rotary shaft 6 is retained by means of two bearing zones, each bearing zone being arranged close to one end of the shaft.

According to the embodiments illustrated in FIGS. 4 to 6, the rotary shaft 6 is radially inside the first guide bearing 21.

In FIGS. 5 and 6, the first guide bearing 21 is a rolling bearing, and the second guide bearing 22 is a rolling bearing.

The outer ring 25 of the first rolling bearing 21 is arranged in a first recess 27 in the enclosure 10. The outer ring 25 is prevented from rotating relative to the first recess 27.

A first portion of the rotary shaft 6 is arranged in the inner ring 23 of the first rolling bearing 21.

A part of the inner lateral surface 6L-i of the rotary shaft 6 forms a part of the at least one outlet channel 8 for the second fluid F2.

A part of the outer lateral surface 6L-e of the rotary shaft 6 is in contact with the inner ring 23 of the first rolling bearing 21.

Similarly, the rotary shaft 6 is, in these examples, radially inside the second rolling bearing 22. The outer ring 26 of the second rolling bearing 22 is arranged in a second recess 28 in the enclosure 10.

A second portion of the rotary shaft 6 is arranged in the inner ring 24 of the second rolling bearing 22.

The outer ring 24, 26 of each rolling bearing 21, 22 is prevented from rotating relative to the enclosure 10. The inner ring 23, 25 of each rolling bearing 21, 22 is prevented from rotating relative to the rotary shaft 6.

For each guide bearing 21, 22, a first seal 31A, 31B is respectively arranged between a first outer lateral surface of the rotary shaft 6 and a first part of the enclosure 10.

For each guide bearing 21, 22, a second seal 32A, 32B is respectively arranged between a second outer lateral surface of the rotary shaft 6 and a second part of the enclosure 10.

The seals mean that the guide bearings for the rotary shaft 6 are not in contact with the first fluid F1 and the second fluid F2.

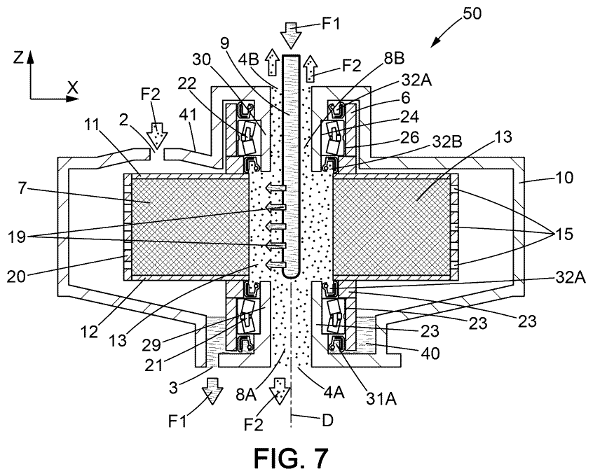

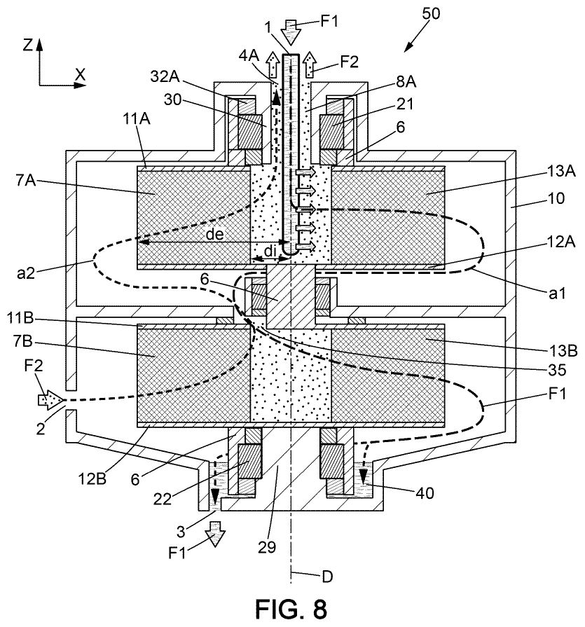

According to the embodiments in FIGS. 7 and 8, the first guide bearing 21 is radially inside the rotary shaft 6.

A first projecting portion 29 of the enclosure 10 is arranged in the inner ring 23 of the first rolling bearing 21.

The outer ring 25 of the first rolling bearing 21 is arranged in a first inner portion of the rotary shaft 6.

In the case of the embodiments in FIGS. 7 and 8, a part of the enclosure 10 forms a portion of the at least one flow channel 8A for the second fluid F2.

Similarly, the second guide bearing 22 is radially inside the rotary shaft 6.

A second projecting portion 30 of the enclosure 10 is arranged in the inner ring 24 of the second rolling bearing 22.

The outer ring 26 of the second rolling bearing 22 is arranged in a second inner portion of the rotary shaft 6.

In the case of the embodiment in FIG. 8, a part of the enclosure 10 forms a portion of the second flow channel 8B for the second fluid F2.

For each rolling bearing 21, 22, the inner ring 23, 24 of the rolling bearing 21, 22 is fixed with respect to the enclosure 10.

For each rolling bearing 21, 22, the outer ring 25, 26 of the rolling bearing 21, 22 is arranged in the rotary shaft 6 and is fixed with respect to the rotary shaft 6.

A first seal 31A, 31B is arranged between a first portion of the inner lateral surface 6L-i of the rotary shaft 6 and a first part of the enclosure 10.

A second seal 32A, 32B is arranged between a second portion of the inner surface 6L-i of the rotary shaft 6 and a second part of the enclosure 10.

The second fluid F2 is in contact with the enclosure 10 at the zone extending from the seal 32A to the first outlet 4A. The second fluid F2 is also in contact with the enclosure 10 at the zone extending from the seal 32B to the second outlet 4B.

According to the example illustrated, the at least one outlet 3 for the first fluid F1 is arranged in a lower portion of the enclosure 10.

When the first fluid F1 is a liquid, a lower portion of the enclosure 10 forms a collection volume 40 for the first fluid F1.

The collection volume 40 forms a liquid accumulation zone. The collection volume 40 communicates with the outlet 3 for the first fluid F1.

The spatial orientation of the rotary contactor 5 can vary.

According to the embodiments in FIGS. 7 to 10, the rotary shaft 6 is oriented in a vertical direction Z.

It should be understood that the axis of the rotary shaft 6 is vertical when the rotary-bed device 50 is in a nominal operating position.

As illustrated in FIG. 7 and in FIG. 8, a part of the outer surface 6L-e of the rotary shaft 6 can be in contact with the liquid present in the collection volume 40.

In particular, one end of the rotary shaft 6 can be arranged in the collection volume 40 for the first fluid F1.

The first seal 31A means that the first fluid F1, in liquid form, cannot seep into the first guide bearing 21.

According to the examples in FIGS. 7, 9 and 10, the first inlet/outlet 2 for the second fluid F2 is arranged on an upper face 41 of the enclosure 10.

The at least one outlet 3 for the first fluid F1 and the at least one second inlet/outlet 4A for the second fluid F2 extend in parallel planes.

The at least one outlet 3 for the first fluid F1 and the at least one second inlet/outlet 4A for the second fluid F2 can be coplanar.

The flow direction of the first fluid F1 at the at least one outlet 3 for the first fluid F1 and the flow direction of the second fluid F2 at the second inlet/outlet 4A are then parallel.

According to the embodiments in FIGS. 1 to 4, the rotary shaft 6 is oriented in a horizontal direction X.

As above, it should be understood that the axis of the rotary shaft 6 is horizontal when the rotary-bed device 50 is in a nominal operating position.

According to a variant (not depicted), the rotary shaft 6 can form any angle with the vertical axis.

The rotary shaft 6 can be oriented in any orientation comprised between a vertical orientation and a horizontal orientation.

According to the example in FIGS. 1 to 4, the first inlet/outlet 2 for the second fluid F2 is arranged on a side face 42 of the enclosure 10.

The at least one outlet 3 for the first fluid F1 and the at least one second inlet/outlet 4A for the second fluid F2 extend, in this example, in perpendicular planes.

The liquid that has accumulated in the collection volume 40 is not in contact with the rotary contactor 5.

The sixth embodiment, illustrated in FIG. 8, illustrates a rotary-bed device comprising two tiered packed beds.

According to this embodiment, the rotary contactor 5 comprises:
a rotary shaft 6,
a first packed bed 7A which is secured to the rotary shaft 6 and configured to allow a transfer of material or a transfer of heat between the first fluid F1 and the second fluid F2,
a second packed bed 7B which is secured to the rotary shaft 6 and configured to allow a transfer of material or a transfer of heat between the first fluid F1 and the second fluid F2.

An outlet of the first packed bed 7A is configured to supply a flow of the first fluid F1 to the second packed bed 7B, and an outlet of the second packed bed 7B is configured to supply a flow of the second fluid F2 to the first packed bed 7A.

The rotary contactor 5 comprises a flow channel 8A for the second fluid F2, configured to cause the second fluid F2 to flow from the first packed bed 7A to the second inlet/outlet 4A for the second fluid F2,

and the flow channel 8A for the second fluid F2 is arranged inside the rotary shaft 6 of the rotary contactor 5.

The first fluid F1 passes successively through the first packed bed 7A and then the second packed bed 7B. The second fluid F2 passes successively through the second packed bed 7B and then the first packed bed 7A.

The use of two packed beds makes it possible to improve the transfer of material, or if appropriate the transfer of heat, between the two fluids F1, F2.

The rotary contactor 5 comprises a first packed bed 7A and a second packed bed 7B rigidly connected to the first packed bed 7A. The first packed bed 7A is held in place by two end plates 11A, 11B. The second packed bed 7B is held in place by two end plates 12A, 12B.

The end plate 12A of the first packed bed 7A is connected to the end plate 11B of the second packed bed 7B by a portion of the rotary shaft 6.

The end plate 11B of the second packed bed 7B comprises at least one through-opening 35B, preferably a set of through-openings 35B.

The first packed bed 7A and the second packed bed 7B may have the same dimensions.

The first fluid F1 leaves the distributor 9, flows through the first packed bed 7A and re-emerges via the periphery of the first packed bed 7A. The first fluid F1 then reaches the second packed bed 7B by passing through the through-orifices 35 in the end plate 11B. The first fluid F1 then flows through the second packed bed 7B and reaches the outlet 3.

The second fluid F2 is admitted via the inlet 2, passes through the second packed bed 7B and re-emerges via the through-openings 35. The second fluid F2 then reaches the outer peripheral edge of the first packed bed 7A, flows through the first packed bed 7A, reaches the first flow channel 8A and exits via the outlet 4A.

The rotary contactor 5 comprises:
a first pair of end plates 11A, 12A secured to the rotary shaft 6 and extending transversely to the rotary shaft 6 at a distance from one another,
a first mixing chamber 13A delimited in an axial direction by the first pair of end plates 11A, 12A, the first mixing chamber 13A extending radially between an inside diameter and an outside diameter, the first packed bed 7A being arranged in the first mixing chamber 13A.

The rotary contactor 5 comprises:
a second pair of end plates 11B, 12B secured to the rotary shaft 6 and extending transversely to the rotary shaft 6 at a distance from one another,
a second mixing chamber 13B delimited in an axial direction by the second pair of end plates 11B, 12B, the second mixing chamber 13B extending radially between an inside diameter and an outside diameter, the second packed bed 7B being arranged in the second mixing chamber 13B.

One end plate 11B of the second pair of end plates 11B, 12B comprises at least one through-orifice 35 configured to allow fluid to pass between the first packed bed 7A and the second packed bed 7B.

The at least one through-orifice 35 is configured to allow the first fluid F1 to pass from the first packed bed 7A to the second packed bed 7B.

The at least one through-orifice 35 is configured to allow the second fluid F2 to flow from the second packed bed 7B to the first packed bed 7A.

The flow channel 8A is in this case an outlet channel for supplying a flow of the second fluid F2.

The rotary shaft 6 is configured to pivot relative to the enclosure 10 by means of a first guide bearing 21 and a second guide bearing 22.

The first guide bearing 21 and the second guide bearing 22 are radially inside the rotary shaft 6.

FIG. 9 describes an embodiment in which the flow of the first fluid F1 and of the second fluid F2 is of the cross-current type.

The first fluid F1 flows, as above, in a radial direction and the second fluid F2 flows in an axial direction.

In this embodiment, the rotary-bed device 50 comprises two inlets 2A, 2B for the first fluid F1.

The two inlets 2A, 2B are arranged on the upper face 41 of the enclosure 10.

The two inlets 2A, 2B face a first end plate 11 of the rotary contactor 5.

The end plate 11 comprises a set of through-openings 36 allowing the second fluid F2 to be admitted into the packed bed 7.

The end plate 12 also comprises a series of through-openings 37, allowing the second fluid F2 to leave the packed bed 7.

The second fluid F2 leaving the packed bed 7 after having been in contact with the first fluid F1 reaches the volume surrounding the rotary shaft 6, passes through the through-apertures 15 in the rotary shaft 6, flows through the flow channel 8A and reaches the outlet 4A arranged in the rotary shaft 6.

A seal 33 is arranged between the first end plate 11 and the enclosure 10, at the radially inner edge of the first end plate 11.

A seal 34 is arranged between the first end plate 11 and the enclosure 10, at the radially outer edge of the first end plate 11.

A seal 35 is arranged between the second end plate 12 and the enclosure 10, at the radially outer edge of the second end plate 12.

The seals 34, 35 prevent the second fluid F2 from being able to pass from one of the inlets 2A, 2B to the inlet/outlet 4A without flowing through the packed bed 7 of the rotary contactor 5. In this embodiment, the rotary shaft 6 is guided in the enclosure 10 by means of a single guide bearing 21 arranged in the lower part of the enclosure 10. The guide bearing is in this case a rolling bearing.

FIG. 10 depicts a variant of the seventh embodiment.

This variant differs from the seventh embodiment by the number of outlets for the second fluid F2. The enclosure 10 comprises a second outlet 4B for the second fluid F2, and a third outlet 4C.

The outlet flow of the second fluid F2 is thus distributed between the outlet 4A arranged in the rotary shaft 6, and the two outlets 4B, 4C arranged in the enclosure 10.

Other embodiments and variants (not depicted) can be implemented. In particular, the rotary-bed device can comprise several outlets for the first fluid F1. The rotary-bed device may comprise more than two packed beds.

### EXAMPLE

The rotary-bed device proposed can be used to capture 1 million tonnes per year of CO2 originating from combustion flue gases from a coal-fired power plant, the combustion flue gas containing 13% CO2. The rotary contactor is configured to allow a capture rate of 90%. The CO2 is for example captured by a solvent consisting of 40% MDEA and 5% piperazine made up with water. The liquid solvent and the combustion flue gases are used in a counter-current arrangement in the rotary contactor.

According to the configuration having a single outlet in the shaft, as depicted in FIG. 1, the drop in pressure between the radially inner edge of the packed bed and the outlet 4A represents approximately 20% of the total drop in pressure of the rotary-bed device.

According to the configuration having two outlets in the shaft, as depicted in FIG. 3, the drop in pressure between the radially inner edge of the packed bed and the outlets 4A, 4B represents approximately 7% of the total drop in pressure of the rotary-bed device.

As a result, the configuration with two outlets in the shaft makes it possible to reduce the drop in pressure between the centre of the rotary-bed device and the gas outlets by approximately 70% in relation to the configuration with a single outlet in the shaft. This makes it possible to use a less powerful fan upstream of the rotary-bed device, thereby allowing the electricity consumption and cost of the fan to be reduced. A reduction of approximately 15% in the electricity consumption and 5% in the cost has been obtained. On the scale of an entire facility for capturing CO2 including regeneration of the solvent, the electricity consumption can thus be reduced by approximately 4%.

1. A rotary-bed device (50), comprising:
at least one inlet (1) for a first fluid (F1),
at least one first inlet/outlet (2) for a second fluid (F2),
at least one outlet (3) for the first fluid (F1),
at least one second inlet/outlet (4A) for the second fluid (F2),
a rotary contactor (5), comprising:
a rotary shaft (6),
a packed bed (7) which is secured to the rotary shaft (6) and configured to allow a transfer of material and/or a transfer of heat between the first fluid (F1) and the second fluid (F2), and
at least one flow channel (8A) for the second fluid (F2), configured to cause the second fluid (F2) to flow from the packed bed (7) to said at least one second inlet/outlet (4A) for the second fluid (F2), or to cause the second fluid (F2) to flow from said at least one second inlet/outlet (4A) for the second fluid (F2) to the packed bed (7),
wherein the at least one flow channel (8A) for the second fluid (F2) is arranged inside the rotary shaft (6) of the rotary contactor (5).

2. The rotary-bed device (50) according to claim 1, wherein the rotary shaft (6) is hollow along at least a part of its length, notably along most or the greater part of its length, notably along all of its length.

3. The rotary-bed device (50) according to claim 1, wherein a part of said at least one flow channel (8A) for the second fluid (F2) extends axially between the packed bed (7) and a first axial end (6a-1) of the rotary shaft (6).

4. The rotary-bed device (50) according to claim 3, wherein the flow channel (8A) has an axial inlet and/or outlet at one of its axial ends.

5. The rotary-bed device (50) according to claim 1, further comprising:
a third inlet/outlet (4B) for the second fluid (F2),
a second flow channel (8B) configured to cause the second fluid (F2) to flow from the packed bed (7) to the third inlet/outlet (4B) for the second fluid (F2), or to cause the second fluid (F2) to flow from the third inlet/outlet (4B) to the packed bed (7), wherein the second flow channel (8B) is arranged inside the rotary shaft (6) of the rotary contactor (5).

6. The rotary-bed device (50) according to claim 5, wherein a part of the second flow channel (8B) for the second fluid (F2) extends axially between the packed bed (7) and a second axial end (6a-2) of the rotary shaft (6).

7. The rotary-bed device (50) according to claim 1, further comprising:
at least one distributor (9) for the first fluid (F1), configured to transfer the first fluid (F1) from said at least one inlet (1) for the first fluid (F1) to the packed bed (7), wherein a portion of said at least one distributor (9) for the first fluid (F1) is arranged inside the rotary shaft (6) of the rotary contactor (5).

8. The rotary-bed device (50) according to claim 7, wherein said at least one distributor (9) comprises a tubular portion (18), and wherein the tubular portion (18) of said at least one distributor (9) and the second flow channel (8B) of the rotary-bed device (50) are coaxial.

9. The rotary-bed device (50) according to claim 1, wherein the rotary contactor (5) further comprises:
two end plates (11, 12) secured to the rotary shaft (6) and extending transversely to the rotary shaft (6) at a distance from one another,
a mixing chamber (13) delimited in an axial direction by the two end plates (11, 12), the mixing chamber (13) extending radially between an inside diameter (di) and an outside diameter (de), the packed bed (7) being arranged in the mixing chamber (13),
wherein the rotary contactor (5) comprises a set of through-apertures (15) for the passage of fluid.

10. The rotary-bed device (50) according to claim 9, wherein the rotary shaft (6) of the rotary contactor (5) comprises a side wall (16), and the set of through-apertures (15) for the passage of fluid is arranged on a part of the side wall (16).

11. The rotary-bed device (50) according to claim 9, wherein the rotary contactor (5) further comprises a connecting element (20) which connects the end plates (11, 12).

12. The rotary-bed device (50) according to claim 1, further comprising an enclosure (10) which forms a support member for holding the rotary contactor (5).

13. The rotary-bed device (50) according to the claim 12, wherein the rotary shaft (6) is configured to pivot relative to the enclosure (10) by means of a single guide bearing (21), and wherein the rotary shaft (6) is radially inside the single guide bearing (21).

14. The rotary-bed device (50) according to claim 12,
wherein the rotary contactor (5) further comprises:
two end plates (11, 12) secured to the rotary shaft (6) and extending transversely to the rotary shaft (6) at a distance from one another,
a mixing chamber (13) delimited in an axial direction by the two end plates (11, 12), the mixing chamber (13) extending radially between an inside diameter (di) and an outside diameter (de), the packed bed (7) being arranged in the mixing chamber (13),
wherein the rotary contactor (5) comprises a set of through-apertures (15) for the passage of fluid, and
wherein the rotary shaft (6) is configured to pivot relative to the enclosure (10) by means 5 of a first guide bearing (21) and a second guide bearing (22), the first guide bearing (21) and the second guide bearing (22) being arranged one on each side of the mixing chamber (13) in an axial direction.

15. The rotary-bed device (50) according to claim 14, wherein:
the rotary shaft (6) is radially inside the first guide bearing (21), and
the rotary shaft (6) is radially inside the second guide bearing (22).

16. The rotary-bed device (50) according to claim 14, wherein:
the first guide bearing (21) is radially inside the rotary shaft (6), and
the second guide bearing (22) is radially inside the rotary shaft (6).

17. The rotary-bed device (50) according to claim 1, wherein the rotary contactor (5) further comprises:
a rotary shaft (6),
a first packed bed (7A) which is secured to the rotary shaft (6) and configured to allow a transfer of material and/or or a transfer of heat between the first fluid (F1) and the second fluid (F2),
a second packed bed (7B) which is secured to the rotary shaft (6) and configured to allow a transfer of material and/or a transfer of heat between the first fluid (F1) and the second fluid (F2),
wherein an outlet of the first packed bed (7A) is configured to supply a flow of the first fluid (F1) to the second packed bed (7B), and
wherein an outlet of the second packed bed (7B) is configured to supply a flow of the second fluid (F2) to the first packed bed (7A),
a flow channel (8A) for the second fluid (F2), configured to cause the second fluid (F2) to flow from the first packed bed (7A) to the second inlet/outlet (4A) for the second fluid (F2), wherein the flow channel (8A) for the second fluid (F2) is arranged inside the rotary shaft (6) of the rotary contactor (5).

18. A method for using the rotary-bed device according to claim 1, comprising:
transferring material and/or heat from one of the two fluids to the other fluid, the two fluids being both liquids or one being a liquid and the other being a gas.
